(19) United States
(12) Patent Application Publication
(10) Pub. No.: US 2025/0198377 A1
(43) Pub. Date: Jun. 19, 2025

(54) FUEL INJECTOR OF AN INTERNAL COMBUSTION ENGINE AND INTERNAL COMBUSTION ENGINE

(71) Applicant: MAN Energy Solutions SE, Augsburg (DE)

(72) Inventors: Thomas KLAUA, Augsburg (DE); Christian KUNKEL, Augsburg (DE); Maximilian INDRICH, Bobingen (DE)

(21) Appl. No.: 18/984,488

(22) Filed: Dec. 17, 2024

(30) Foreign Application Priority Data
Dec. 19, 2023 (DE) 10 2023 135 721.2

(51) Int. Cl. F02M 61/18; F02M 61/10

(52) U.S. Cl. CPC F02M 61/1846; F02M 61/10

(57) ABSTRACT

A fuel injector having a first nozzle needle in a first needle guide, which either opens or blocks a fuel flow of a first fuel through first fuel injection orifices, a second nozzle needle, which either opens or blocks a fuel flow of a second fuel for igniting the first fuel, through second fuel injection orifices. The first fuel injection orifices are arranged along a pitch circle contour and the second fuel injection orifices along a circular contour such that a distance between the centre point of the pitch circle contour and the centre point of the circular contour is greater than the sum of the radius of the pitch circle contour and the radius of the circular contour. In the installed state of the fuel injector the second fuel injection orifices project further into a combustion chamber of the cylinder than the first fuel injection orifices.

### BACKGROUND OF THE INVENTION

### 1. Field of the Invention

The disclosure relates to a fuel injector of an internal combustion engine and to an internal combustion engine having at least one fuel injector.

The disclosure present here relates in particular to the field of so-called large engines or large internal combustion engines, the cylinders of which have piston diameters of at least 140 mm, in particular of at least 175 mm. Such large internal combustion engines are typically for ships' engines.

### 2. Description of Related Art

Dual-fuel internal combustion engines are already known as ships' engines. Dual-fuel internal combustion engines known from practice can be operated in a first operating mode, in which the same combust a first fuel, in particular a relatively less ignitable fuel, and in a second operating mode, in which the same combust a second fuel, in particular a relatively ignitable fuel.

The first relatively less ignitable fuel can be for example methanol, ethanol, or ammonia. The second relatively ignitable fuel can be for example a diesel fuel. In the first operating mode, the first relatively less ignitable fuel, in particular the methanol, ethanol, or ammonia, can be ignited via the second relatively ignitable fuel, in particular the diesel fuel.

DE 10 2013 000 048 B3 discloses a fuel injector with the help of which in the first operating mode of a dual-fuel internal combustion engine both the first relatively less ignitable fuel and also the second relatively ignitable fuel can be introduced into the combustion chamber of a cylinder. The fuel injector disclosed there is embodied as so-called dual needle injector, which comprises two nozzle needles, which are moveably guided in corresponding needle guides. First fuel injection orifices interacting with a first nozzle needle and second fuel injection orifices interacting with a second nozzle needle are each arranged along a circular contour, wherein in the installed state of the fuel injector the first fuel injection orifices and the second fuel injection orifices project equally deep or far into the combustion chamber of the cylinder. This produces significant restrictions when injecting the fuels into the combustion chamber of a cylinder, so that the combustion space of the combustion chamber cannot be optimally utilised. Accordingly, when in particular in a second operating mode for example exclusively relatively ignitable fuel is to be combusted, a significant portion of the combustion space of the combustion chamber can no longer be filled with the relatively ignitable fuel.

### SUMMARY OF THE INVENTION

The present invention is a new type of fuel injector of an internal combustion engine and an internal combustion engine having such a fuel injector.

The fuel injector comprises a first nozzle needle moveably guided in a first needle guide, which interacts with first fuel injection orifices in such a manner that the first nozzle needle, depending on its position either opens or blocks a fuel flow of the first, relatively less ignitable fuel through the first fuel injection orifices.

Further, the fuel injector comprises a second nozzle needle moveably guided in a second needle guide which interacts with second fuel injection orifices in such a manner that the second nozzle needle, depending on its position, either opens or blocks a fuel flow of a second, relatively ignitable fuel, which serves for igniting the first fuel, through the second fuel injection orifices.

The first fuel injection orifices of the fuel injector are arranged along a pitch circle contour and the second fuel injection orifices along a circular contour in such a manner that a distance between the centre point of the pitch circle contour and the centre point of the circular contour is greater than the sum of the radius of the pitch circle contour and of the radius of the circular contour.

In the installed state of the fuel injector, the second fuel injection orifices project deeper or further into the combustion chamber of the cylinder than the first fuel injection orifices.

With the fuel injector according to the invention it is provided that those fuel injection orifices of the fuel injector, which serve for introducing the relatively ignitable fuel into the combustion chamber of a cylinder, project, in the installed state of the fuel injector, deeper or further into the combustion chamber of the cylinder than the first fuel injection orifices, which serve for introducing the relatively less ignitable fuel into the combustion chamber of the cylinder. Thus, both the first, relatively less ignitable fuel and also the second, relatively ignitable fuel can be advantageously introduced into the combustion chamber, so that a combustion space of the combustion chamber can be optimally utilised. In particular when in a corresponding operating mode of the internal combustion engine exclusively relatively ignitable fuel is to be combusted, the readily ignitable fuel can be optimally introduced into the combustion chamber.

Preferentially, the pitch circle contour, on which the first fuel injection orifices are arranged, cover an angular range of 360°-δ, wherein δ amounts to between 15° and 60°, in particular between 20° and 60°, preferably between 20° and 45°, and wherein the pitch circle contour defined by the angle δ faces the circular contour on which the second fuel injection orifices are arranged. The circular contour, on which the second fuel injection orifices are arranged, covers an angular range of 360°. This allows both an optimal introduction of the first, relatively less ignitable fuel and also of the second, relatively ignitable fuel into the combustion chamber of a cylinder.

Preferentially, a ratio between a height offset of the circular contour, on which the second fuel injection orifices are arranged, and the pitch circle contour, on which the first fuel injection orifices are arranged, and the distance between the centre point of the pitch circle contour and the centre point of the circular contour amounts to between 0.1 and 0.4, in particular between 0.15 and 0.35, preferably between 0.17 and 0.29. This is also advantageous for optimally introducing the first relatively less ignitable fuel and the second, relatively ignitable fuel into the combustion chamber of the cylinder.

Preferentially, the first fuel injection orifices are equipped for injecting the first fuel in a first spray cone with a first cone angle into the combustion space, wherein the second fuel injection orifices are equipped for injecting the second fuel in a second spray cone with a second cone angle into the combustion space, wherein the first cone angle is smaller than the second cone angle. The first cone angle preferentially amounts to between 66° and 88°, in particular between 68° and 86°, particularly preferably between 70° and 84°. The second cone angle preferentially amounts to between 70° and 92°, in particular between 72° and 90°, particularly preferably between 74° and 88°. Thus, introducing the first relatively less ignitable fuel and the second relatively ignitable fuel into the combustion chamber of the respective cylinder can be further improved.

### BRIEF DESCRIPTION OF THE DRAWINGS

Preferred further developments of the invention are obtained from the subclaims and the following description. Exemplary embodiments of the invention are explained in more detail by way of the drawing without being restricted to this.

There it shows:

FIG. 1: is a schematic lateral view of a fuel injector;

FIG. 2: is a view of the fuel injector;

FIG. 3 is a schematic cross-section through the fuel injector of FIG. 1.

### DETAILED DESCRIPTION OF THE PRESENTLY PREFERRED EMBODIMENTS

The invention relates to a fuel injector of an internal combustion engine. Such a fuel injector is designed for supplying fuel to a combustion chamber of a cylinder of the internal combustion engine. The fuel injector according to the invention serves for supplying different fuels to an internal combustion engine configured in particular as dual-fuel internal combustion engine, thus in a first operating mode for introducing a first, in particular relatively less ignitable fuel, and a second, relatively ignitable fuel in order to ignite via the second relatively ignitable fuel the first relatively less ignitable fuel in the first operating mode. Further, in a second operating mode, in which exclusively the second relatively less ignitable fuel is combusted, the same is to be injected into the combustion chamber of the cylinder via the fuel injector. The first relatively less ignitable fuel can be methanol, ethanol or ammonia. The second relatively ignitable fuel is in particular a diesel fuel.

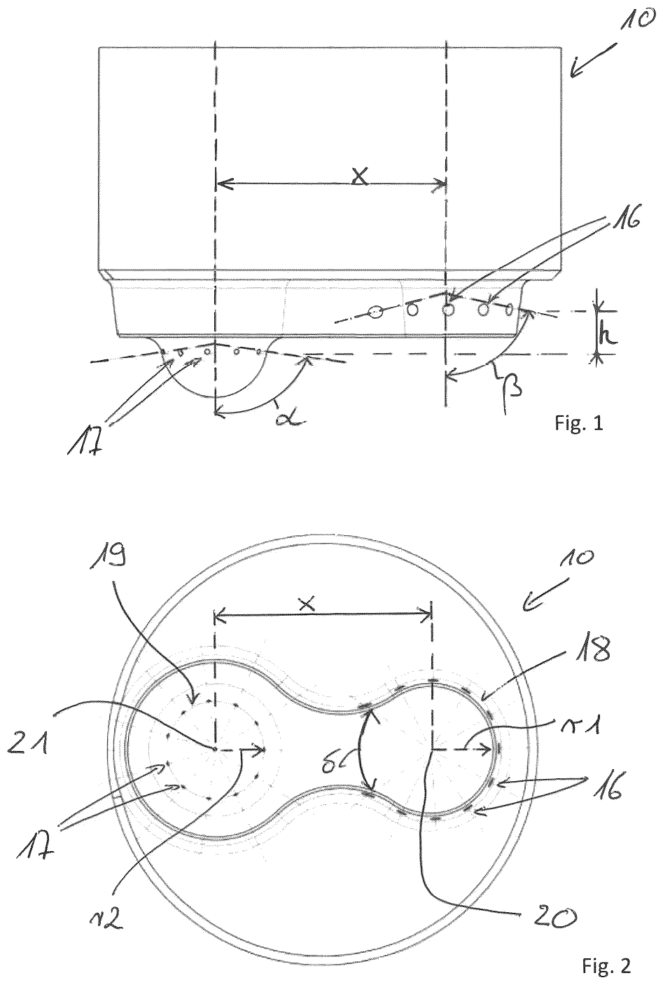

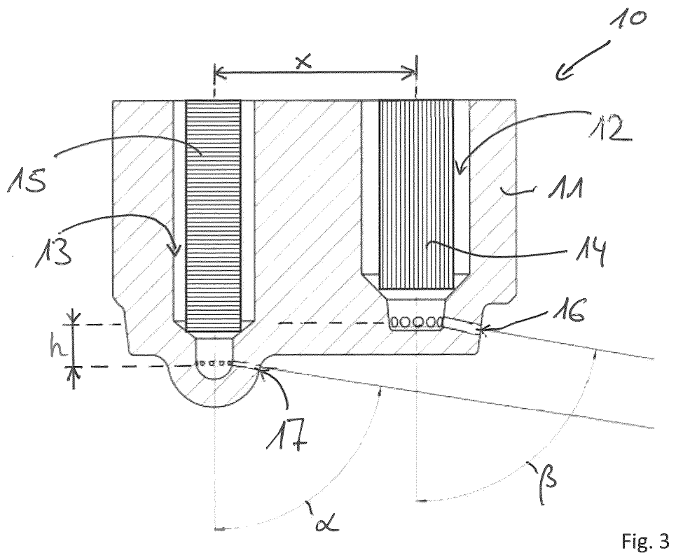

FIGS. 1 to 3 show different views of a fuel injector 10 according to aspects of the invention. The fuel injector 10 has a main body 11, which provides two needle guides 12, 13.

In a first needle guide 12, a first nozzle needle 14 and in a second needle guide 13 a second nozzle needle 15 are moveably guided. With the first nozzle needle 14, first fuel injection orifices 16 interact in such a manner that the first nozzle needle 14, depending on its position in the first needle guide 12 either opens or blocks a fuel flow of a first, relatively less ignitable fuel through the first fuel injection orifices 16. With the second nozzle needle 15, second fuel injection orifices 17 interact in such a manner that the second nozzle needle 15, depending on its position in the second needle guide 13, either opens or blocks a fuel flow of a second, relatively ignitable fuel, which in a corresponding operating mode of the internal combustion engine serves for igniting the first relatively less ignitable fuel, through the second fuel injection orifices 17.

Accordingly, when the internal combustion engine is operated in an operating mode in which the first, relatively less ignitable fuel is to be combusted and ignited with the help of the second relatively ignitable fuel, the first relatively less ignitable fuel is introduced via the first fuel injection orifices 16 and the second relatively ignitable fuel via the second fuel injection orifices 17 into the combustion chamber of the cylinder. When in a second operating mode of the internal combustion engine exclusively the second relatively less ignitable fuel is to be combusted, the same is introduced into the combustion chamber of the cylinder via the second fuel injection orifices 17, the first fuel injection orifices 16 are then permanently closed by the first nozzle needle 14.

The first fuel injection orifices 16 are arranged along a pitch circle contour 18 and the second fuel injection orifices 17 along a circular contour 19. The pitch circle contour 18 has a radius r1 and the circular contour 19 a radius r2. A distance x between the centre point 20 of the pitch circle contour 18 and the centre point 21 of the circular contour 19 is greater than the sum of the two radii r1 and r2.

Accordingly, the pitch circle contour 18 and the circular contour 19 are not arranged concentrically to one another and do not intersect one another.

In the installed state of the fuel injector 10, the second fuel injection orifices 17 are then arranged deeper or further in the combustion chamber of the cylinder than the first fuel injection orifices 16. In FIG. 1, the height offset h visualises the distance of the plane of the pitch circle contour 18 from the plane of the circular contour 19. Accordingly, the circular contour 19 with the second fuel injection orifices 17 projects in the installed state of the fuel injector 10 deeper or further into the combustion chamber of the cylinder by the height offset h than the pitch circle contour 18 with the first fuel injection orifices 16.

The circular contour 19, on which the second fuel injection orifices 17 are arranged, covers an angular range of 360°. Preferentially, however not exclusively, the second fuel injection orifices 17 are arranged equidistantly spaced on this circular contour 19.

Accordingly, the second relatively ignitable fuel can be injected into the combustion chamber in an angular range of 360° via the second fuel injection orifices 17.

The pitch circle contour 18, on which the first fuel injection orifices 16 are arranged, covers an angular range of 360°-δ. δ amounts to between 15° and 65°, in particular between 20° and 60°, in particular preferably between 20° and 45°-δ. Accordingly, δ defines a residual pitch circle contour on which no first fuel injection orifices 16 are arranged. On the pitch circle contour 18, the first fuel injection orifices 16 are preferentially but not exclusively arranged equidistantly spaced apart. The residual pitch circle contour defined by δ, on which no first fuel injection orifices 16 are arranged, faces the circular contour 19, on which the second fuel injection orifices 17 are arranged.

Preferentially, a ratio h/x between the height offset h of the circular contour 19, on which the second fuel injection orifices 17 are arranged, and the pitch circle contour 18, on which the first fuel injection orifices 16 are arranged, and the distance x between the centre point 20 of the pitch circle contour 18 and the centre point 21 of the circular contour 19 amounts to between 0.1 and 0.4, in particular between 0.15 and 0.35, preferably between 0.17 and 0.29.

As already explained, the height offset h is the distance between the plane of the circular contour 19 on which the second fuel injection orifices 17 are arranged, and the plane of the pitch circle contour 18, on which the first fuel injection orifices 16 are arranged. The distance x corresponds to the distance between the centre point 20 of the pitch circle contour 18 and the centre point 21 of the circular contour 19.

As already explained, the first fuel injection orifices 16 are equipped for injecting the first relatively less ignitable fuel into the combustion chamber of the cylinder, namely with a first spray cone which is characterised by the cone angle β. This cone angle β corresponds to the angle between the lateral surface of the spray cone and a longitudinal centre axis of the same. The second fuel injection orifices 17 are equipped for injecting the second relatively ignitable fuel in a second spray code with a second cone angle α into the combustion chamber, wherein the second cone angle α in turn amounts to the angle between the lateral surface of the second spray cone and the longitudinal centre axis of the same.

The first cone angle β is smaller than the second cone angle α. In particular, the first cone angle β amounts to between 66° and 88°, in particular between 68° and 86°, particularly preferably between 70° and 84°. The second cone angle α amounts to between 70° and 92°, in particular between 72° and 90°, particularly preferably between 74° and 88°.

One aspect of the invention allows optimally introduced fuel into the combustion chamber of a cylinder in different operating modes of an internal combustion engine preferentially configured as dual-fuel internal combustion engine. Thus, in a first operating mode, both a first relatively less ignitable fuel and for igniting the same a second relatively ignitable fuel, as well as in a second operating mode, the second relatively ignitable fuel can be optimally introduced into the combustion chamber of a cylinder and thus combusted.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A fuel injector of an internal combustion engine configured to supply fuel to an internal combustion chamber of a cylinder of the internal combustion engine, comprising:
a first nozzle needle moveably guided in a first needle guide, which interacts with first fuel injection orifices such that the first nozzle needle, depending on its position either opens or blocks a first fuel flow of a first fuel, which is a relatively less ignitable fuel, through the first fuel injection orifices;
a second nozzle needle moveably guided in a second needle guide, which interacts with second fuel injection orifices such that the second nozzle needle, depending on its position, either opens or blocks a second fuel flow of a second fuel, which is a relatively ignitable fuel for igniting the first fuel, through the second fuel injection orifices;
wherein the first fuel injection orifices are arranged along a pitch circle contour and the second fuel injection orifices are arranged along a circular contour such that a distance between a centre point of the pitch circle contour and a centre point of the circular contour is greater than a sum of a radius of the pitch circle contour and a radius of the circular contour, and
wherein in an installed state of the fuel injector the second fuel injection orifices project deeper or further into the internal combustion chamber of the cylinder than the first fuel injection orifices.

2. The fuel injector according to claim 1,
wherein the circular contour, on which the second fuel injection orifices are arranged, covers an angular range of 360°.

3. The fuel injector according to claim 1,
wherein the pitch circle contour, on which the first fuel injection orifices are arranged, covers an angular range of 360°-δ, wherein δ is between 15° and 60°,
wherein a residual pitch circle contour defined by δ, on which no first fuel injection orifices are arranged, faces the circular contour, on which the second fuel injection orifices are arranged.

4. The fuel injector according to claim 1,
wherein a ratio between a height offset of the circular contour, on which the second fuel injection orifices are arranged, and the pitch circle contour, in which the first fuel injection orifices are arranged, and
wherein the distance between the centre point of the pitch circle contour and the centre point of the circular contour is between 0.1 and 0.4.

5. The fuel injector according to claim 1,
wherein the first fuel injection orifices are configured to inject the first fuel in a first spray cone with a first cone angle into a combustion space, and
wherein the second fuel injection orifices are configured to inject the second fuel in a second spray cone with a second cone angle into the combustion space,
wherein the first cone angle is smaller than the second cone angle.

6. The fuel injector according to claim 5,
wherein the first cone angle is between 66° and 88°, and
wherein the second cone angle is between 70° and 92°.

7. An internal combustion engine, comprising:
cylinders configured to ignite with help of a second fuel a first fuel for combusting the first fuel in the cylinders; and
a fuel injector for each cylinder comprising:
a first nozzle needle moveably guided in a first needle guide, which interacts with first fuel injection orifices such that the first nozzle needle, depending on its position either opens or blocks a first fuel flow of the first fuel, which is a relatively less ignitable fuel, through the first fuel injection orifices;
a second nozzle needle moveably guided in a second needle guide, which interacts with second fuel injection orifices such that the second nozzle needle, depending on its position, either opens or blocks a second fuel flow of the second fuel, which is a relatively ignitable fuel and which serves for igniting the first fuel, through the second fuel injection orifices;
wherein the first fuel injection orifices are arranged along a pitch circle contour and the second fuel injection orifices are arranged along a circular contour such that a distance between a centre point of the pitch circle contour and a centre point of the circular contour is greater than a sum of a radius of the pitch circle contour and a radius of the circular contour, and
wherein in an installed state of the fuel injector the second fuel injection orifices project deeper or further into an internal combustion chamber of a respective cylinder than the first fuel injection orifices.

8. The fuel injector according to claim 3, wherein δ is between 20° and 60°.

9. The fuel injector according to claim 3, wherein δ is between 20° and 45°.

10. The fuel injector according to claim 4, wherein the distance between the centre point of the pitch circle contour and the centre point of the circular contour is between 0.17 and 0.29.

11. The fuel injector according to claim 6, wherein the first cone angle is between 70° and 84°.

12. The fuel injector according to claim 6, wherein the second cone angle is between 74° and 88°.
